(19) United States
(12) Patent Application Publication
(10) Pub. No.: US 2012/0226988 A1
(43) Pub. Date: Sep. 6, 2012

(54) System for Information Collation and Display

(76) Inventors: Deepak Sharma, Pune (IN); Yash Purohit, Pune (IN); Anita Nanadikar, Mumbai (IN); Anil Sharma, Pune (IN)

(21) Appl. No.: 13/365,252

(22) Filed: Feb. 2, 2012

Related U.S. Application Data
(63) Continuation of application No. PCT/IN2010/000517, filed on Aug. 3, 2010.

(30) Foreign Application Priority Data
Aug. 3, 2009 (IN) 1781/MUM/2009

(51) Int. Cl. G06F 3/048; G06F 15/16

(52) U.S. Cl. 715/738

(57) ABSTRACT

A system and a method for collating and displaying information, the system comprising display creation means; template creation means; interactive means; editing means; browsing means; and multi-platform deployment means. The system can be used with multiple platforms including web based social networking, mobile based social networking, advertising, enterprise management, and 3rd party support. The method including the steps of enabling interaction with pre-determined information; creating a multi-dimensional templates having surfaces for display of information; displacing the created surfaces said displacement including moving the surfaces, rotating the surfaces and scaling the surfaces up and down; editing the information displayed on the surfaces; browsing information on said surfaces selectively; and deploying the system to be used with multiple platforms.

### CROSS-REFERENCE TO RELATED APPLICATIONS

This application is a continuation of PCT Patent Application Serial Number PCT/IN2010/000517, filed on Aug. 3, 2010, entitled, “System for Information Collation and Display,” which claims priority from Indian Patent Application Serial Number 1781/MUM/2009, filed on Aug. 3, 2009, entitled, “System for Information Collation and Display.”

### FIELD

This disclosure relates to the field of information systems and particularly to a system for information collation and display.

### BACKGROUND

With the advent Internet and its proliferation across continents has led to hosting, reproducing, editing, management and storage of enormous amount of data and information online. Individuals, Institutions and Organizations alike are producing a lot of content, providers such as Editorials, Analysts, and Consumer Generated Media (News, Blogs and Reviews etc) constitute a major chunk of this information.

Most of the content is being refreshed at a rapid pace and is shared using universal accepted mechanisms such as RSS and ATOM Feeds. These feeds provide web content or summaries of web content together with links to the full versions of the content, and other meta-data. Users of these feeds are reading the content provided by these feeds in clients known generally as RSS Readers.

While such RSS readers provide a very simple usage where each item in the RSS feed is presented as a block of content, looking at the content in an interactive manner remains a challenge. Moreover, managing variety content or information in an integrated interactive manner is needed in order to facilitate easy and swift access to the readers or users.

Several systems have been implemented before in order to have organized structure for information display like U.S. Pat. No. 6,710,788 where a graphical user interface is provided which uses a representation of a polyhedron, such as a cube, having images on each face for representing multiple desktops used in conjunction with an operating system. User can switch the desktop by pressing the faces of the cube.

But, this system is limited to multiple desktop display and does not display the information received from user feeds RSS and ATOM feeds. Also, the system posses low interactive capabilities which leads to low integration of information.

Hence, there is felt a need for a system which can collate information and provide such collated information in a dynamic and interactive manner; provide a higher degree of information integration; provide a web compatible system that targets users accessing the system using a Web browser; and provide a mobile compatible system, for touch enabled mobile phones that targets users accessing the platform through a mobile application.

### Objects:

Some of the objects of the present disclosure are as follows:

An object of this disclosure is to provide a system and apparatus for collating information and viewing such collated information in a dynamic and interactive manner.

Another object of the present disclosure is to provide a system which provides a higher degree of information integration.

Yet another object of the disclosure is to provide a web compatible system that targets users accessing the system using a Web browser and be able to view the information on cube surfaces or in a slide show manner or in a manner that provides a scatter of surfaces on the view and be able to scroll surfaces in and out of view.

Still another object of the disclosure is to provide a mobile compatible system, for touch enabled mobile phones that targets users accessing the system through a mobile application.

### SUMMARY

In accordance with an aspect of the present disclosure a system for collating and displaying information is provided, the system comprising
display creation means for enabling interaction with pre-determined information;
template creation means for creating at least one multidimensional template having plurality of surfaces for display of information, said template creation means adapted to divide each of said surfaces of the multi-dimensional template into predetermined number of cells;
aggregating means adapted to receive the information to be displayed from diversified sources including at least web feeds data, RSS feeds data, pictures, photos, documents, audio and video, said aggregating means further adapted to aggregate the information received from said diversified sources;
interactive means adapted to displace the created surfaces the displacement including moving the surfaces, rotating the surfaces, zooming the surfaces in and out, and scaling the surfaces up and down;
editing means adapted to edit the information displayed on the surfaces;
browsing means adapted, to selectively browse information on the surfaces; and
multi-platform deployment means adapted to deploy the system to be used with multiple platforms, the multiple platforms including web based social networking, mobile based social networking, advertising, enterprise management, and 3^{rd} party support.

Typically, the surfaces define a polyhedron which is preferably a cube.

Typically, the system includes storing means for storing information in the form of clouds.

Typically, the template creation means includes means to create predefined cells on the surfaces of the polyhedron.

Typically, the editing means has means to edit data on the surfaces at the cell level.

Typically, the system includes marking means adapted to mark a particular polyhedron as a favorite, deletion means adapted to delete information on the surfaces, activity updation means adapted to update the information on the surfaces.

Typically, the system includes touch facilitation means adapted to facilitate the use of the system and the polyhedrons on a touch sensitive hand held device, the hand held device selected from the group consisting of mobile phone, iPod, tablet PC, computer, television, and PDA.

In accordance with another aspect of the present disclosure there is provided a method for collating and displaying information comprising the steps of
enabling interaction with pre-determined information;
creating at least one multi-dimensional template having polyhedron surfaces for display of information and dividing each of said surfaces of the multi-dimensional template into n² cells;
receiving the information to be displayed from diversified sources including at least web feeds data, RSS feeds data, pictures, photos, documents, audio and video, and aggregating the information received from said diversified sources;
displacing the created surfaces the displacement including moving the surfaces, rotating the surfaces and scaling the surfaces up and down;
editing the information displayed on the surfaces;
browsing information on the surfaces selectively; and
deploying the system to be used with multiple platforms.

Typically, the method includes the step of storing information in the form of clouds.

### BRIEF DESCRIPTION OF THE ACCOMPANYING DRAWINGS

Other aspects of the disclosure will become apparent by consideration of the accompanying drawings and their description stated below, which is merely illustrative of a preferred embodiment of the disclosure and does not limit in any way the nature and scope of the disclosure.

FIG. 1 illustrates various forms of polyhedrons used for displaying information in accordance with the present disclosure;

FIG. 2 illustrates a face of the polyhedrons displaying an opinion poll in accordance with an exemplary embodiment;

FIG. 3 illustrates a block diagram of a system for collating and displaying information in accordance with the present disclosure;

FIG. 4 illustrates zooming operations on the polyhedron in accordance with the present disclosure;

FIG. 5 illustrates the rotational operation performed on the polyhedron in accordance with the present disclosure;

FIG. 6 illustrates an example of a polyhedron which contains different types of contents on different surfaces in accordance with the present disclosure;

FIG. 7 illustrates different activities that can be performed using the system according to an exemplary embodiment of the disclosure;

FIG. 8 illustrates a different format of display of information or content of a polyhedron; and

FIG. 9 illustrates a method for collating and displaying information as envisaged by the present disclosure.

### DETAILED DESCRIPTION OF THE ACCOMPANYING DRAWINGS

The drawings and the description thereto are merely illustrative of a system for collating and displaying information and only exemplify the disclosure and in no way limit the scope thereof.

In order to overcome the shortcomings of the prior art the present disclosure proposes a system for collating and display information where the ‘Information’ for the purposes of this disclosure includes various kinds of feeds data (including the popular RSS/ATOM feeds) and social content (User Generated Media—pictures, documents, videos, audio) and the like.

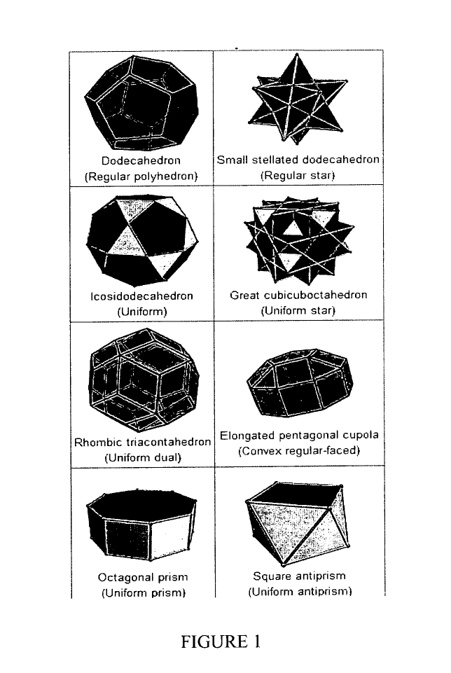

In accordance with an aspect of the present disclosure the system, enables information from all such feeds to be presented in a polyhedron like structure. The polyhedron as envisaged by the present disclosure can be of various forms such as dodecahedron, icosidodecahedron, triacontahedron, octagonal prism, anti-prism and the like as shown in FIG. 1.

For instance the polyhedron can be a polyhedron which is a three dimensional structure that has six faces and each face has n² cells where n is the number from 1 to 6.

In accordance with the disclosure, each cell can be bound with a distinct piece of information. The information which can be bound to each cell/face of the polyhedron can be web feeds, consumer generated content i.e. uploading and displaying personalized contents like photos, documents and videos that user can upload from a computer. Whenever the user binds the polyhedron's face/cell to consumer generated content, the data (e.g. Videos/Photos/Documents etc) and metadata associated with this data is stored on a remote cloud storage platform.

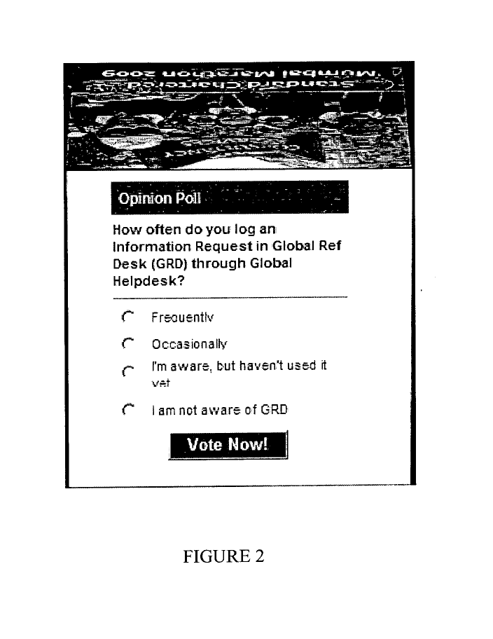

In accordance with the disclosure the face of the polyhedrons can also show forms like survey, registration and poll forms as shown in FIG. 2. The users can interact with the form published on the polyhedron face and perform intended action. A cloud storage platform allows an application to automatically scale based upon the user load. It also allows data to be accessible to various devices or platforms over Internet.

In accordance with the disclosure, information to be displayed in the cells on the surfaces of the polyhedrons is aggregated from different sources including content providers or user produced content or organization data or social feeds/sharing and the like which is then used by the system.

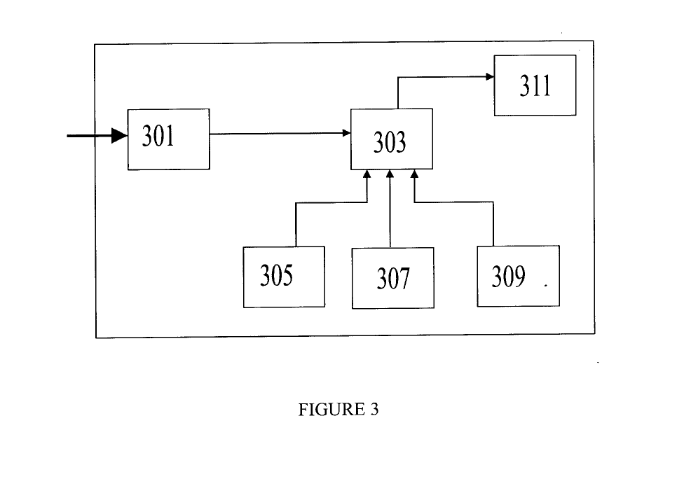

Referring to FIG. 3, there is shown a system 300 for collating and display of information where display creation means 301 displays information and enables interaction with the information. A template creation means 303 is adapted to create a multi-dimensional template (Preferably a 3-dimensional template like polyhedron) for providing surfaces for display of information. The template creation means is adapted to divide each of the polyhedron surfaces of the multi-dimensional template into preferably n² cells.

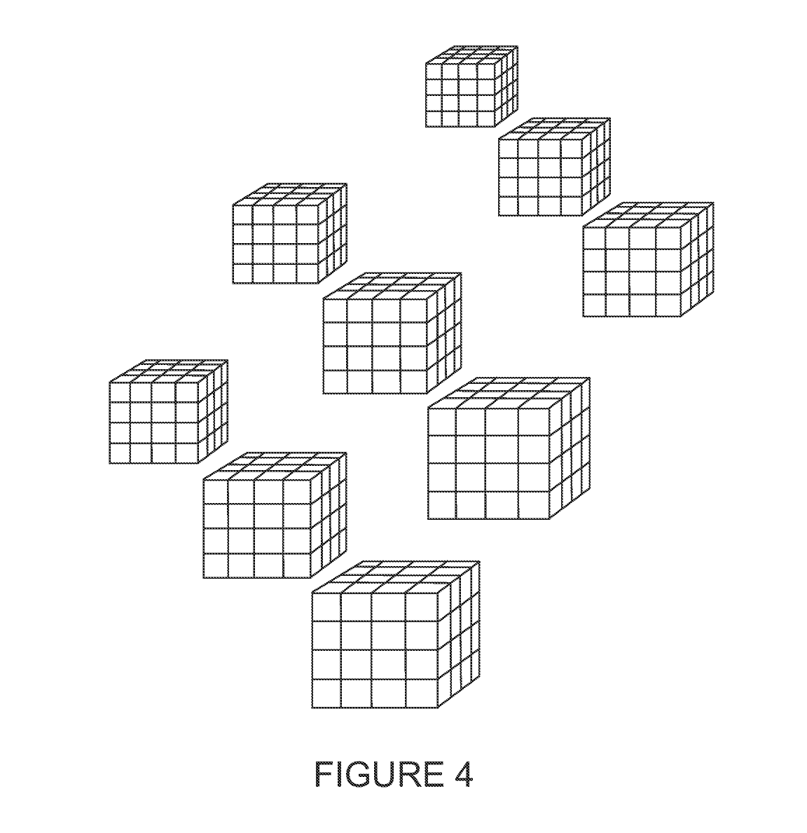

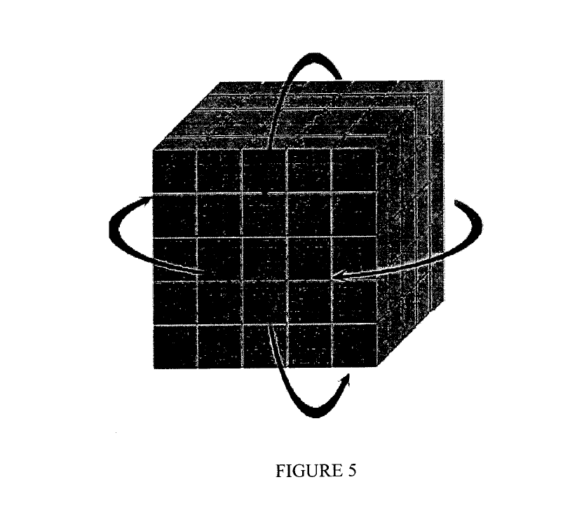

Further an interactive means 305 is provided to displace the created surfaces of the 3-D polyhedron structures in a visually appealing way i.e. scaling the surfaces up and down, zooming in and out (as shown in FIG. 4), moving the surfaces, rotating the surfaces (as shown in FIG. 5) and/or changing colour, colour schemes. Hence, the system encourages interactive social networking.

Still further an editing means 307 is provided which is adapted to edit the information displayed in different cells on the surfaces of the 3-D polyhedron structures, this editing may be in the form of change of information, change of surfaces containing information, change in the type of information and the like.

Browsing means 309 is provided to facilitate selective browsing of information distributed in number of cells on the surfaces of the 3-D polyhedron structure.

In accordance with another embodiment of this disclosure, there is provided a multi-platform deployment means 311 for sharing of the 3-D polyhedron structures containing information with friends, consumers, enterprises and the like entities or users. The multi-platform deployment means 311 includes social sharing means, web facilitation means, mobile facilitation means, advertising means, enterprise management means, and 3^{rd} party application interface means. These means brings in under given functionalities to the system.

Social sharing means for sharing the polyhedrons with friends using the current existing popular Social Networks. Also, the social sharing means allows users to share polyhedrons, created by anyone, with their friends through several channels including email, posts in popular social networking sites, SMS, MMS, internet, POD cast and the like.

Web facilitation means adapted to facilitate users accessing the system using a Web browser. Web facilitation means provides a platform for social networking using web browsers by which interactive polyhedrons can be created by the users, using the system and distributed to other users on a dedicated platform or other famous Social Networking platforms like Facebook, Linkedln, MySpace, Orkut and the like in order to facilitate Social Networking.

Mobile facilitation means adapted for touch-enabled mobile phones that targets users accessing the platform through a mobile application. Mobile facilitation means provides a similar social networking platform using mobile phones.

Advertising means adapted to produce interactive and visually appealing advertises, that aggregate brand experiences and messages and information through a rich interactive Polyhedron. This will allow Marketers to traffic the 3D Media polyhedrons to sites of publishers using a display ad specification. Through a script, marketers will be able to traffic this to publisher's websites using any existing Ad Network means or Ad Exchange means.

Enterprise management means adapted to allow enterprises to create and promote their own channels by publishing their content using polyhedrons. Typical enterprises which would use this form of promotion will include Media & Entertainment companies, Content Providers, Publishers and the like. Also, enterprise management means provides an innovative way to allow users to play with their content and a new medium for bring traffic to their respective websites using the polyhedrons built on the Platform. Using enterprise management means, enterprises can form online ad campaigns put them on the web and mobile implementations. These advertisements and promotions are displayed when the user is working with the system.

3^{rd} party application interface means adapted to support 3rd party applications. Using the application interface means, 3rd party applications can develop their own widgets to interact with the system. In accordance with another aspect of the present disclosure the system includes touch facilitation means adapted to facilitate operation using a touch enabled mobile phone by allowing viewing of a 3 dimension polyhedron structure which gives a unique experience on a touch enabled mobile phones, using figure tips for invoke the functionalities like:
Rotating a polyhedron;
Zooming in or zooming out a polyhedron;
Selecting a polyhedron; and
tapping on a cell of a polyhedron to view the article description, photos or videos or take action on an interactive form like poll or survey.

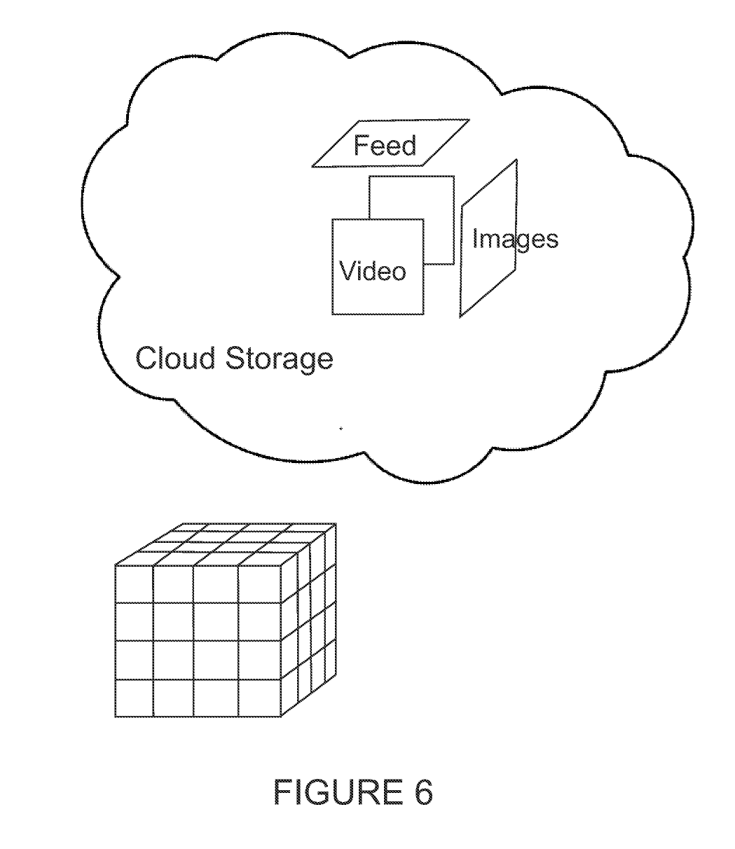

In accordance with still another aspect of the present disclosure, different polyhedron surfaces or cells can have different contents for instance music, videos, RSS feeds and the like which can be stored in the storage clouds and can be accessed anytime later, as shown in FIG. 6.

In accordance with an exemplary embodiment users can aggregate personal information in ‘mixed’ polyhedrons for instance users can have photos of their recent vacation on one face; they can have videos of the same trip bound to other face; they can have blogs or articles for the same trip bound to other face of the same polyhedron; they can also have a form like poll or survey where friends can participate. Also, different content can be placed in different cells on the same face.

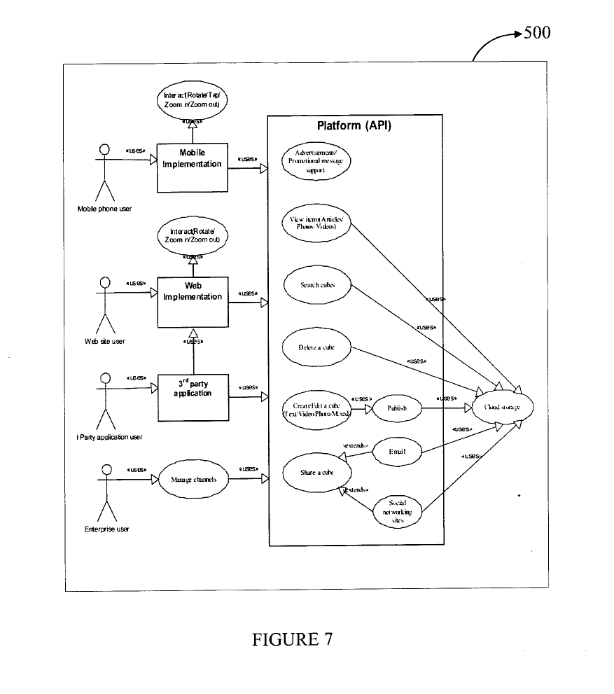

Referring to FIG. 7 there are illustrated different activities generally represented by reference numeral 700 that can be performed using the system, in accordance with another exemplary embodiment.

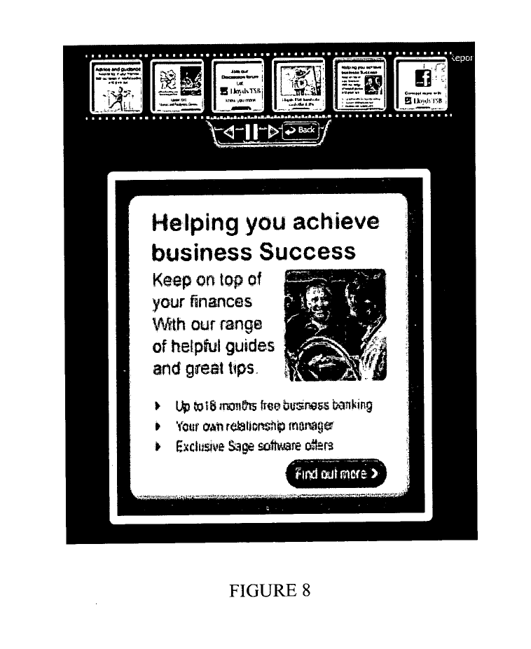

In accordance with still another aspect of the present disclosure the information displayed on the surfaces of the polyhedrons can also be viewed different formats. Referring to FIG. 8 there is illustrated a different format of display of information or content of a polyhedron in the form of a slide show or moving images with interactive functions as envisaged by the present disclosure.

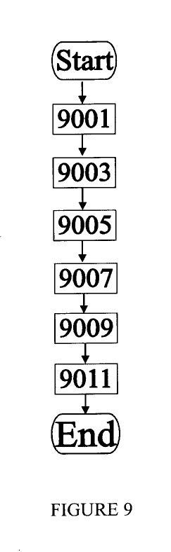

In accordance with still further an aspect of the present disclosure, a method for collating and displaying information is provided as shown in FIG. 9, the method comprising the steps of
enabling interaction with pre-determined information, 9001;
creating at least one multi-dimensional template having polyhedron surfaces for display of information and dividing each of said surfaces of the multi-dimensional template into n² cells and
receiving the information to be displayed from diversified sources including at least web feeds data, RSS feeds data, pictures, photos, documents, audio and video, and aggregating the information received from said diversified sources, 9003;
displacing the created surfaces said displacement including moving the surfaces, rotating the surfaces and scaling the surfaces up and down, 9005;
editing the information displayed on the surfaces, 9007;
browsing information on said surfaces selectively, 9009; and
deploying the system to be used with multiple platforms, 9011.

### Technical Advancements:

The technical advancements of the disclosure include in providing
a system and apparatus for collating information and viewing such collated information in a dynamic and interactive manner;
a system which provides a higher degree of information integration;
a web compatible system that targets users accessing the system using a Web browser; and
a mobile compatible system, for touch enabled mobile phones that targets users accessing the system through a mobile application.

While considerable emphasis has been placed herein on the particular features of the preferred embodiment and the improvisation with regards to it, it will be appreciated the various modifications can be made in the preferred embodiments without departing from the principles of the disclosure. These and the other modifications in the nature of the disclosure will be apparent to those skilled in art from disclosure herein, whereby it is to be distinctly understood that the foregoing descriptive matter is to interpreted merely as illustrative of the disclosure and not as a limitation.

What is claimed is:

1. A system for collating and displaying information comprising
display creation means for enabling interaction with pre-determined information;
template creation means for creating at least one multi-dimensional template having plurality of polyhedron surfaces for display of information, said template creation means adapted to divide each of said surfaces of the multi-dimensional template into n² cells;
aggregating means adapted to receive the information to be displayed from diversified sources including at least web feeds data, RSS feeds data, pictures, photos, documents, audio and video, said aggregating means further adapted to aggregate the information received from said diversified sources;
interactive means adapted to displace the created surfaces, said displacement including moving the surfaces, rotating the surfaces, zooming the surfaces in and out, and scaling the surfaces up and down;
editing means adapted to edit the information displayed on the surfaces;
browsing means adapted to selectively browse information on said surfaces; and
multi-platform deployment means adapted to deploy the system to be used with multiple platforms, said multiple platforms including web based social networking, mobile based social networking, advertising, enterprise management, and 3^{rd} party support.

2. The system as claimed in claim 1, wherein said surfaces define a polyhedron.

3. The system as claimed in claim 1, wherein said surfaces define a cube.

4. The system as claimed in claim 1, wherein the system includes storing means for storing information in the form of clouds.

5. The system as claimed in claim 1, wherein said editing means has means to edit data on the surfaces at the cell level.

6. The system as claimed in claim 1, wherein said system includes marking means to mark a particular polyhedron as favorite.

7. The system as claimed in claim 1, wherein the system includes deletion means adapted to delete information on the surfaces.

8. The system as claimed in claim 1, wherein the system includes activity updation means adapted to update the information on the surfaces.

9. The system as claimed in claim 1, wherein the system includes touch facilitation means adapted to facilitate the use of the system and the polyhedrons on a touch sensitive hand held device, said hand held device selected from the group consisting of mobile phone, iPod, tablet PC, computer, television, and PDA.

10. A method for collating and displaying information comprising the steps of
enabling interaction with pre-determined information;
creating at least one multi-dimensional template having polyhedron surfaces for display of information and dividing each of said surfaces of the multi-dimensional template into n² cells;
receiving the information to be displayed from diversified sources including at least web feeds data, RSS feeds data, pictures, photos, documents, audio and video, and aggregating the information received from said diversified sources;
displacing the created surfaces, said displacement including moving the surfaces, rotating the surfaces and scaling the surfaces up and down;
editing the information displayed on the surfaces;
browsing information on said surfaces selectively; and
deploying the system to be used with multiple platforms.

11. The method as claimed in claim 10, wherein the method includes the step of storing information in the form of clouds.
